(19) United States
(12) Patent Application Publication
(10) Pub. No.: US 2011/0005037 A1
(43) Pub. Date: Jan. 13, 2011

(54) HANDLE STRUCTURE FOR COOKING INSTRUMENT

(76) Inventor: Jong Deuk Kim, Busan (KR)

Correspondence Address: CHRISTOPHER PAUL MITCHELL, 888 16TH ST., NW, SUITE 800, WASHINGTON, DC, 20006, US

(21) Appl. No.: 12/922,684

(22) PCT Filed: Sep. 16, 2008
(86) PCT No.: PCT/KR08/05447

§ 371 Date: Sep. 14, 2010

(30) Foreign Application Priority Data
Mar. 14, 2008 (KR) 20-2008-0003345

(51) Int. Cl. B25G 3/00

(52) U.S. Cl. 16/422

(57) ABSTRACT

A handle structure for a cooking instrument. A body has an opening in a lower portion thereof. A lever is hinged to the body, and is exposed to the outside of the body through the opening. A clamp is housed in the body, is elastically supported by a first spring on one side thereof, and extends in a lengthwise direction such that a contact part thereof is exposed to the front of the body. A clamp contacting unit has a pivoting bar and an operating bar so as to be linked with the lever by a pivot pin moving along operation slots of the lever at a predetermined angle. A holder is exposed to the front of the body. A button is exposed to the outside of the body, and has a lower end thereof that presses down the operating bar to return the clamp.

### TECHNICAL FIELD

The present invention relates, in general, to a handle structure for a cooking instrument, and more particularly, to a handle structure for a cooking instrument, in which cooking is done with a handle detached from the cooking instrument, and then the handle is attached to the hot cooking instrument, thereby moving the hot cooking instrument in an easy and safe manner.

### Background Art

In general, cooking instruments are divided into pots, pans, fry pans, etc. according to a process of cooking various foods, and are heated on a heating apparatus in order to cook, for instance boil or roast, the foods.

Typically, the cooking instruments have one or two handles protruding to the outside. Thus, any user can grasp the handle after cooking, and then carry the cooking instrument to a desired position. For the cooking, the cooking instruments are heated for a long time by a heat source such as a gas stove, so that heat is transmitted to the handle. Thus, the user is in danger of suffering a burn when grasping the handle. For example, since ttuk-bae-gi (a deep bowl capable of deliciously cooking special foods such as doenjang (soybean paste)) is produced without a handle due to a material characteristic that uses soil as a raw material, protection gloves or pincers are used to transfer the ttuk-bae-gi when it has been heated to a high temperature. In this process, the user may misgrab the ttuk-bae-gi by mistake, which results in hurting surrounding persons.

In order to solve this problem, a handle for a cooking instrument which can be attached to or detached from the cooking instrument is variously disclosed, for instance, in Korean Utility Model Registration Nos. 20-422596 (titled “Separable and Joinable Vessel Handle”), and 20-166097 (titled “Handle Structure for Cooking Instrument”).

In order to address various problems associated with the aforementioned prior arts, the present applicant filed a utility model application, and got Korean Utility Model Registration No. 20-439045 (titled “Detachable Handle for Cooking Vessels”). In this document, the detachable handle for cooking vessels generally includes a body of the handle, a driven part, a support, a driven part contacting means, and a driven part restoring part, detailed description of which will be omitted for the sake of convenience.

However, the detachable handle for cooking vessels has a problem in that the fixing force of an elastic plate for fixing a lever is weak, and thus the driven part is not firmly fixed to the cooking vessel, and furthermore in that the elastic plate bends elastically when the driven part is fixed, and thus the fixation is released.

Further, while the handle is grasped, it is difficult to turn over the handle in order to release and restore the fixing force of the driven part, which causes inconvenience to a user. In addition, malfunction between a push rod of the handle and an operational pin of the lever frequently occurs, and thus the driven part is not smoothly returned. Further, when the lever is pulled to operate the driven part in order to fix the handle to the cooking vessel, and when the push rod of the handle is turned over to return the driven part, the push rod cannot be operated due to interference with the driven part, or the operational pin or the push rod becomes damaged.

### DISCLOSURE OF INVENTION

### Technical Problem

Accordingly, the present invention has been made in an effort to solve the problems occurring in the related art, and embodiments of the present invention provide a handle structure for a cooking instrument, which is attachable to or detachable from various cooking instruments having different sizes in a firm and easy manner, and thus enhances convenience of use.

### Technical Solution

In order to achieve the above object, according to an embodiment of the present invention, there is provided a handle structure for a cooking instrument, which comprises: a body having an opening in a lower portion thereof and grasped by a hand; a lever hinged to the lower portion of the body by a lever pin so as to be pivoted at a predetermined angle and exposed to an outside of the body through the opening; a clamp housed in the body, elastically supported by a first spring on one side thereof, and extending in a lengthwise direction such that a contact part thereof is exposed to a front of the body; a clamp contacting means having a pivoting bar hinged to the body in a rear of the lever and an operating bar coupled with the clamp such that the pivoting bar and the operating bar are linked with the lever by a pivot pin moving along operation slots of the lever at a predetermined angle; a holder exposed to the front of the body on an upper side of the clamp; and a button exposed to the outside of the body and having a lower end thereof that presses down the operating bar to return the clamp.

According to another embodiment of the present invention, the holder may be elastically pulled in a backward direction by a second spring housed in the body.

According to another embodiment of the present invention, the body may include a third spring that elastically contacts and returns the button.

Additional advantages, objects, and features of the invention will be more apparent from the following detailed description based on the accompanying drawings. First, the terms and words used in the present specification and claims should not be construed as being restricted to ordinary and customary meanings or dictionary definitions, but be interpreted to comply with the technical spirit of the present invention based on the principle by which an inventor can define the concepts implicated by terms in order to best explain his or her invention.

### Advantageous Effects

According to embodiments of the present invention, the handle structure for a cooking instrument can firmly attach or easily detach a handle to or from the cooking instrument in a one-touch fashion, so that it provides convenience to anyone and so that it can be used in a safe and easy manner. Further, the handle structure prevents the handle fixed to the cooking instrument from spontaneously detaching itself therefrom, that is prevents dropping of the cooking instrument, when it is being transferred.

When the handle is attached to the cooking instrument, a holder elastically supports the cooking instrument, so that the handle is firmly attached despite a change in the thickness of the cooking instrument. Accordingly, the handle structure can be widely applied to various cooking instruments having different sizes.

In addition, as in a typical cooking instrument having a handle, the handle can be attached to the cooking instrument during cooking.

### BRIEF DESCRIPTION OF THE DRAWINGS

FIG. 1 is a perspective view illustrating the external geometry of a handle structure for a cooking instrument according to an exemplary embodiment of the invention;

FIG. 2 is a cross-sectional view illustrating a handle structure for a cooking instrument according to an exemplary embodiment of the invention which is cut off in a lengthwise direction;

FIG. 3 is a top plan view taken along line A-A of FIG. 2;

FIG. 4 is a cross-sectional view illustrating the operation of a handle structure for a cooking instrument according to an exemplary embodiment of the invention; and

FIG. 5 is a top plan view taken along line B-B of FIG. 4 in order to illustrate the operation of a handle structure for a cooking instrument according to an exemplary embodiment of the invention.

### MODE FOR THE INVENTION

Reference will now be made in greater detail to a handle structure for a cooking instrument according to an exemplary embodiment of the invention with reference to the accompanying drawings.

First, it should be noted that, wherever possible, the same reference numerals will be used throughout the drawings and the description to refer to the same or like parts. Further, the detailed descriptions of known functions and constructions which would unnecessarily obscure the subject matter of the present invention will be avoided hereinafter.

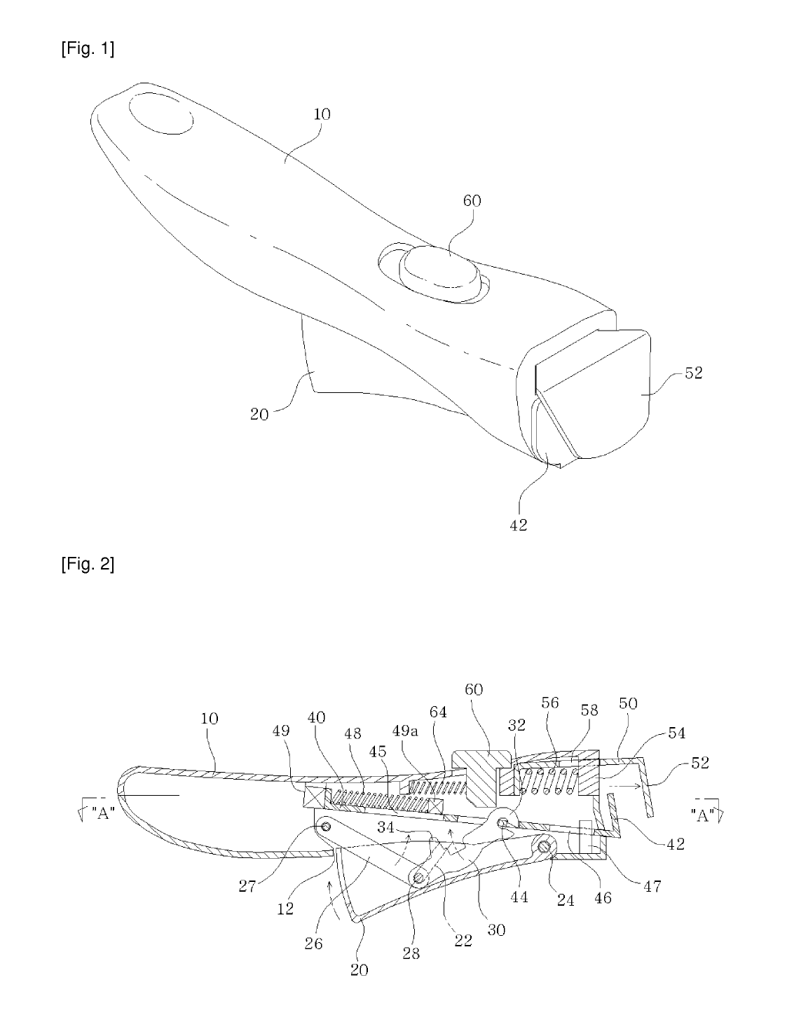

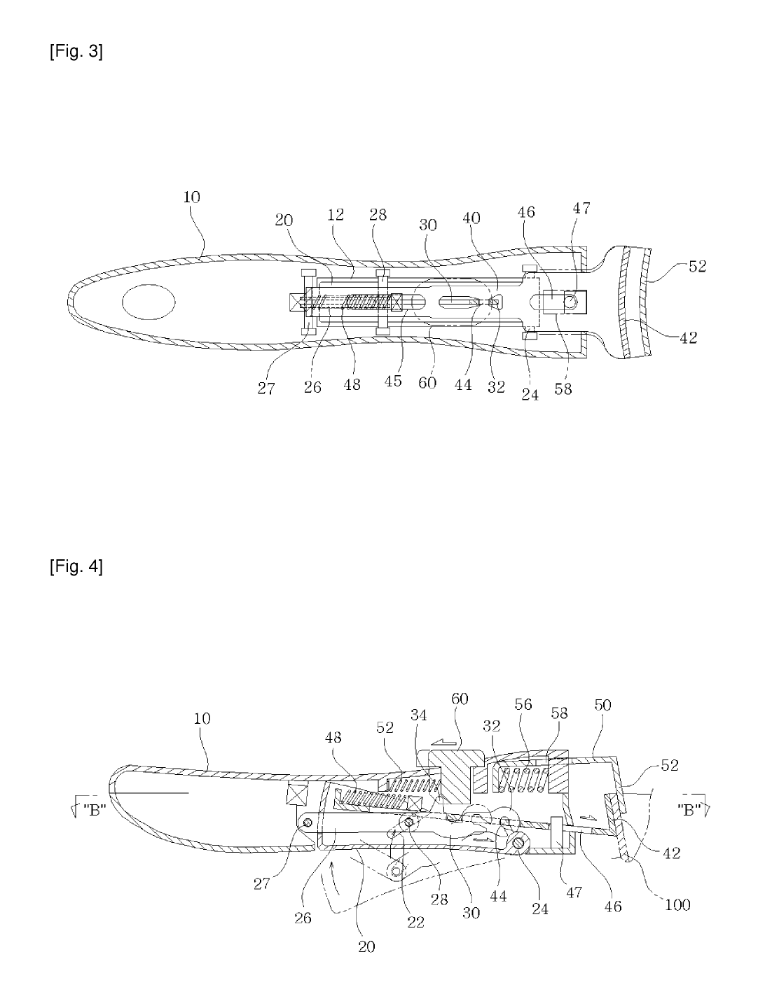

FIG. 1 is a perspective view illustrating the external geometry of a handle structure for a cooking instrument according to an exemplary embodiment of the invention. FIG. 2 is a cross-sectional view illustrating a handle structure for a cooking instrument according to an exemplary embodiment of the invention which is cut off in a lengthwise direction. FIG. 3 is a top plan view taken along line A-A of FIG. 2.

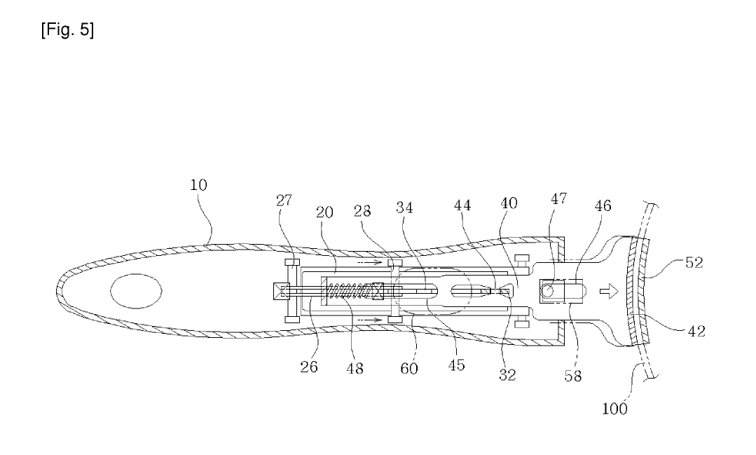

FIG. 4 is a cross-sectional view illustrating the operation of a handle structure for a cooking instrument according to an exemplary embodiment of the invention, and FIG. 5 is a top plan view taken along line B-B of FIG. 4 in order to illustrate the operation of a handle structure for a cooking instrument according to an exemplary embodiment of the invention.

Referring to the figures, a body 10 has a streamlined shape so as to be conveniently grasped by the hand, is divided into upper and lower parts so as to define an internal space, and is provided with an opening 12 in the bottom thereof.

The body 10 includes a clamp 40 extending in a lengthwise direction in the shape of a flat plate, and a holder 50 above the clamp 40. The clamp 40 and the holder 50 are provided with a contact part 42 and a fixing part 52, which protrude toward the front of the body, so as to be firmly and closely contacted and fixed in engagement with the cooking instrument.

The clamp 40 extends from the interior of the body to the front of the body in a lengthwise direction. Guide rails (not shown) are provided in the body 10 on opposite sides of the clamp so as to move back and forth in a lengthwise direction. Preferably, the clamp 40 is provided with a rectangular guide hole 46 in front thereof. The body 10 is provided with a guide rod 47 fixed to the front inner side thereof. The guide rod 47 of the body 10 is inserted into the guide hole 46 so as to come into slidable contact with the guide hole 46. Thereby, the guide rod 47 allows the clamp to be guided without swaying left and right and to exert a contacting force in a forward direction.

The clamp 40 is pulled backwards in the body by the elastic force of a first spring 48, and then is contacted with and stopped by a stopper 49 provided in the rear of the body. The first spring 48 is supported on a stopper 49a fixed to the body at one end thereof.

Of course, the body is provided with guide rails (not shown) on a front inner side thereof which guide forward/backward movement of the holder 50. The holder 50 is slidably engaged with a guide 54 of the body, which passes through a guide hole 58 extending in a lengthwise direction. Here, the holder 50 is elastically supported in the rear thereof by a second spring 56 that is in contact with the guide 54 in the body, and is stopped by a stopper due to a contacting force of the second spring 56 applied in a backward direction.

The contact part 42 and the fixing part 52 are bent upwards and downwards at front ends thereof so as to overlap with each other in order to closely contact the cooking instrument. The fixing part 52 is spaced apart from the contact part 42 in the front of the contact part 42 by a predetermined distance such that the cooking instrument 100 is interposed between the contact part 42 and the fixing part 52.

The body includes a lever 20 for operating the clamp 40, and a clamp contacting means. The contacting means is made up of a pivoting bar 26 and an operating bar 30, both of which cooperate with the lever.

The lever 20 is assembled with the body on a front lower side of the body by a lever pin 24, pivots around the lever pin 24 within a predetermined angle on a rear lower side of the body, and is exposed to the outside of the body through an opening 12. The lever 20 has a concave space, and is provided with operation slots 22 inclined upwards in a forward direction on opposite sides of the middle portion thereof.

A pivot pin 28 is assembled to the operation slots 22, and thus operates along the operation slots 22. The pivot pin 28 is coupled with one end of the pivoting bar 26 and one end of the operating bar 30 such that the pivoting bar 26 is connected with the operating bar 30.

The other end of the pivoting bar 26 inclinedly extends upwards in the rear direction of the lever, and is coupled with the body through a hinge pin 27 so as to pivot around the hinge pin 27 within a predetermined angle. The operating bar 30 inclinedly extends upwards in the front direction of the lever, and is assembled so that a connecting rod 44 provided in the middle of the clamp 40 is inserted into a coupler 32 formed at an end of the operating bar 30, thereby cooperating with the clamp. In detail, the pivoting bar 26 and the operating bar 30 are coupled with each other through the pivot pin 28 so as to be inclined upward in a V shape as in FIG. 2.

The operating bar 30 includes the coupler 32 having a C-shaped slot so as to be fitted around the connecting rod 44 for simple assembly, and a protrusion 34 in the middle thereof. The protrusion 34 protrudes upwards from the clamp when the operating bar is operated, but does not interfere with the clamp due to a through-hole 45 formed in the clamp.

A button 60 is installed above the operating bar, and is exposed outside the body. The button 60 is adapted so that an inclined part 62 formed at a lower end thereof presses the operating bar and thereby returns the clamp. The button 60 is elastically pushed from the rear to the front by a third spring mounted in the body, and thereby is returned forwards.

In an embodiment of the present invention, the handle structure for a cooking instrument configured as described above will be described in terms of its operation. This description will make it easy to understand the handle structure for a cooking instrument.

FIG. 4 is a cross-sectional view illustrating the operation of a handle structure for a cooking instrument according to an embodiment of the invention, and FIG. 5 is a top plan view taken along line B-B of FIG. 4, and illustrating the operation of a handle structure for a cooking instrument according to an embodiment of the invention.

As described above, before the handle structure for a cooking instrument according to an embodiment of the invention is attached to the cooking instrument 100, the lever 20 protrudes downwards from the body as in FIGS. 2 and 3. At this time, the clamp 40 is pushed in a backward direction by the elastic force of the first spring, and simultaneously the pivot pin 28 is located on a lower side of the operation slots. Thus, a distance between the hinge pin 27 and the connecting rod 44 becomes short as in FIG. 4.

Next, as illustrated in FIGS. 4 and 5, the contact part 42 and the fixing part 52 are fitted around the cooking instrument 100, and then the lever 20 is grasped by the hand. Then, the lever is pivoted around the lever pin 24, and simultaneously the pivoting bar 26 is also pivoted around the hinge pin. Thereby, the pivot pin 28 inclinedly moves along the operation slots 22 in a forward direction. At this time, the operating bar 30 is also operated to push the connecting rod 44 in a forward direction, and simultaneously the clamp 40 moves in a forward direction. Thereby, the contact part presses and contacts an outer surface of the cooking instrument.

In detail, the pivoting bar 26 and the operating bar 30 are stretched from a V-shaped state to a linear state by the operation of the lever, and thus the clamp 40 moves forwards. At this time, the distance between the hinge pin 27 and the connecting rod 44 reaches a maximum, and the pivot pin 28 is located above a linear position where the pivoting bar 26 and the operating bar 30 are stretched. As such, the clamp is not returned, and thus is fixed.

At this time, the fixing part 52 of the holder 50 is pushed forwards by a pressing force of the clamp, and more firmly fixes the cooking instrument due to an elastic restoring force of the second spring.

Generally, the cooking instrument 100 shows a tendency that its thickness is proportional to its size. In this case, the contact part and the fixing part can be firmly fixed to the cooking instrument regardless of the thickness of the cooking instrument 100.

Afterwards, a rear end of the elastic plate is pivotably coupled in the body 10 by an assembly pin 38. Thus, as in FIG. 1, when the lever 30 is pushed upwards, the lever and the elastic plate are folded in a substantially liner shape, and are stretched in forward and backward directions. Thereby, a driven part moves forwards. At this time, the lever and the elastic plate are further folded upwards, and thus the driven part is not returned, i.e. is fixed. The cooking instrument is fixed between the contacting plate and the fixing plate. Meanwhile, when the contacting plate comes into close contact with the fixing plate, the fixing plate is pushed in a forward direction, and then further contacts the cooking instrument by the elastic force of the second spring.

Next, in order to release the clamp 40 firmly fixed as described above, the button 60 has to be pulled in a backward direction.

As the button 60 moves in a backward direction, the inclined part 62 formed at the lower end of the button presses down the protrusion 34, and simultaneously the pivot pin 28 is lowered from the linear position where the pivoting bar 26 and the operating bar 30 are stretched. At this time, the clamp is pushed backwards by the elastic restoring force of the first spring, and the pivot pin 28 moves down along the operation slots 22. The pivoting bar 26 and the operating bar 30 are folded in the original V-shaped state again, and thus the lever 20 returns to the state in which it is exposed to the outside of the body.

In this manner, the simple operation that operates the button 60 in a backward direction causes the clamp to be returned in a backward direction, so that the handle can be easily detached from the cooking instrument 100.

As described above, in the handle structure for a cooking instrument according to an embodiment of the present invention, as the lever is operated, the clamp moves forwards, and thus is firmly attached to the cooking instrument 100. Further, the fixing force of the handle is released by the simple operation that pulls the button 60 of the body, so that the handle can be easily detached from the cooking instrument. Preferably, the contact part of the clamp 40 and the fixing part of the holder 50 which are formed of metal are manufactured so as to be sufficiently spaced apart from the body 10 formed of plastic, thereby preventing heat of the heat source from being easily transmitted to the handle.

In the drawings and specification, a typical exemplary embodiment of the invention has been disclosed, and although specific terms are employed, they are used in a generic and descriptive sense only and are not for the purposes of limitation, the scope of the invention being set forth in the following claims.

1. A handle structure for a cooking instrument, comprising:
a body (10) having an opening (12) in a lower portion thereof and grasped by a hand;
a lever (20) hinged to the lower portion of the body by a lever pin so as to be pivoted at a predetermined angle and exposed to an outside of the body through the opening;
a clamp (40) housed in the body, elastically supported by a first spring (48) on one side thereof, and extending in a lengthwise direction such that a contact part (42) thereof is exposed to a front of the body;
a clamp contacting means having a pivoting bar (26) hinged to the body in a rear of the lever and an operating bar (30) coupled with the clamp such that the pivoting bar and the operating bar are linked with the lever by a pivot pin (28) moving along operation slots (22) of the lever at a predetermined angle;
a holder (50) exposed to the front of the body on an upper side of the clamp; and
a button (60) exposed to the outside of the body and having a lower end thereof that presses down the operating bar to return the clamp.

2. The handle structure as set forth in claim 1, wherein the holder (50) is elastically pulled in a backward direction by a second spring (56) housed in the body.

3. The handle structure as set forth in claim 1, wherein the body (10) includes a third spring (64) that elastically contacts and returns the button (60).
